(19) United States
(12) Patent Application Publication
(10) Pub. No.: US 2005/0255200 A1
(43) Pub. Date: Nov. 17, 2005

(54) Food packaging bag, food-packaged body, and method for manufacturing the same

(75) Inventors: Atsuko Takahagi, Shinjuku-Ku (JP); Kozo Mita, Shinjuku-Ku (JP)

Correspondence Address: BURR & BROWN, PO BOX 7068, SYRACUSE, NY, 13261-7068, US

(73) Assignee: DAI NIPPON PRINTING CO., LTD., Shinjuku-Ku (JP)

(21) Appl. No.: 11/052,535

(22) Filed: Feb. 7, 2005

(30) Foreign Application Priority Data
May 17, 2004 (JP) 2004-146463
Jul. 14, 2004 (JP) 2004-207363

(51) Int. Cl. A23B 4/00

(52) U.S. Cl. 426/113

(57) ABSTRACT

The present invention provides a food packaging bag, which can hermetically seal and pack foods therein for long-term storage of the foods and can realize cooking in a safe manner, a food-packaged body, and a method for manufacturing the food-packaged body. Preferably, the present invention provides a food packaging bag, which, in a food packed state, does not undergo breakage of the seal upon exposure to pressure or impact applied during transport or storage and, at the time of serving, even when placed in the hermetically sealed state in a microwave oven followed by heating, can automatically lower the internal pressure to prevent the burst of the bag, and a food-packaged body, and a method for manufacturing the food-packaged body. The food-packaged body consists essentially of: a food packaging bag formed of a laminated film comprising at least a base layer and a sealant layer, the sealant layer being located on the interior side of the packaging bag, the packaging bag having therewithin a point seal part connected to or independently of its edge, the point seal part having in its inside an easy-vapor-passing part; and a food which has been packed and hermetically sealed in the packaging bag.

### TECHNICAL FIELD

The present invention relates to a food packaging bag, which can hermetically seal and pack foods, particularly cooked rices (for example, cooked white rice, Sekihan (steamed rice mixed with red beans), pilaf, rice seasoned and cooked with various ingredients) therein for long-term storage of the foods and can realize cooking in a safe manner, a food-packaged body comprising a food packed into a food packaging bag, and a method for manufacturing the same.

Preferably, the present invention relates to a retort food packaging bag, for a microwave oven, which, in a food packed state, does not undergo breakage of the seal upon exposure to pressure or impact applied during transport or storage and, at the time of serving, even when placed in the hermetically sealed state in a microwave oven followed by heating, does not cause the burst of the bag and can automatically lower the internal pressure, and can be self-supported, can be easily taken out of the microwave oven, and is also excellent in display effect at the store, and a food-packaged body, and a method for manufacturing the same.

### BACKGROUND ART

In recent years, a demand for simplified food cooking has led to extensive distribution of cooked processed foods in such a food-packaged body form that the cooked processed foods are packed in a hermetically sealed state in plastic packaging bags or the like followed by retort sterilization for imparting storage stability. The food-packaged bodies can advantageously be stored for a long period of time and enables foods to be easily served by simply warming the food-packaged bodies in a microwave oven.

In this food-packaged body, there is a need to previously cut a part of the packaging bag with scissors to form a vent before heating in the microwave oven (see, for example, Japanese Patent Laid-Open Nos. 28063/1999 and 72187/2000). If he or she has inadvertently heated the food-packaged body in a hermetically sealed state without opening a part of the packaging bag in a microwave oven, steam generated from the contents increases the pressure within the bag and, in many cases, finally causes the burst of the bag which disadvantageously results in scatter of foods within the microwave oven. In this case, even though the burst of the bag could be avoided, disadvantageously, satisfactory cooking is impossible. Further, previously opening a part of the packaging bag poses additional problems including that water is excessively evaporated resulting in hard heated foods and foods become sticky due to dew condensation water making it impossible to provide delicious foods.

To overcome these problems, a packaging bag for a microwave oven has been proposed (see, for example, Japanese Patent No. 3006528). This packaging bag is characterized by providing a weak-seal thin-film tape in a part of a heat seal part in a packaging bag in such a manner that, when the pressure within the packaging bag has risen to a predetermined value or higher, the weak-seal tape is peeled to open a vent. The packaging bag disclosed in Japanese Patent No. 3006528 is sealed so that peeling is likely to take place from the weak-seal face. This poses a problem that, upon exposure to external pressure and impact applied during the course of distribution, the contents are leaked from the weak-seal face. Further, it is disadvantageously difficult for the packaged body to undergo satisfactory retort sterilization.

A packaging bag for a microwave oven in a flat pouch form that a part of a heat seal part has been narrowed has also been proposed (see, for example, Japanese Patent Laid-Open No. 72070/1998). In this packaging bag, however, the flat pouch form is disadvantageous in that, when a liquid material is packed into the bag, the packed material spills from the opening. Further, Japanese Patent Laid-Open Nos. 185777/2000, 327046/2000, and 182779/2003 propose other packaging bags for a microwave oven.

### DISCLOSURE OF THE INVENTION

An object of the present invention is to provide a food packaging bag, which can hermetically seal and pack foods, particularly cooked rices (for example, cooked white rice, Sekihan (steamed rice mixed with red beans), pilaf, rice seasoned and cooked with various ingredients) therein for long-term storage of the foods, has no fear of causing the contents to be leaked from a seal face upon exposure to external pressure or impact during the course of distribution, and, even upon heating of the food-packaged body in a hermetically sealed state in a microwave oven, does not cause the burst of the packaging bag, automatically discharges excessive steam to the outside of the bag without boiling-over of the foods, does not render the food sticky and mealy and can provide delicious foods, is self-supportable, and enables the packaged body to be easily taken out of the microwave oven in a safe manner, and a method for manufacturing a food-packaged body.

The above object can be attained by a food packaging bag formed of a laminated film comprising at least a base layer and a sealant layer, characterized in that said sealant layer is located on the interior side of said packaging bag, said packaging bag has therewithin a point seal part connected to or independently of its edge, and said point seal part has in its area an easy-vapor-passing part.

The food packaging bag according to the present invention is also characterized in that said easy-vapor-passing part is provided at such a position that, when circles are drawn about the center part of said packaging bag, the radius of the circle in contact with the inner edge of the lowermost end in said easy-vapor-passing part from the center of said packaging bag is smaller than the radius of the circle in contact with the inner edge of the edge in said packaging bag.

The food packaging bag according to the present invention is also characterized in that said point seal part has in its area an unbonded part, a weakly bonded part, or a patterned seal part.

The food packaging bag according to the present invention is also characterized in that said easy-vapor-passing part is at least one notch or cut provided in the area of said point seal part.

The food packaging bag according to the present invention is also characterized in that the distance between the lowermost end of said at least one notch or cut provided in said point seal part and the lower end of said point seal part is 2 to 10 mm.

The food packaging bag according to the present invention is also characterized in that said point seal part has a seal strength of not less than 23 N/15 mm and not more than 100 N/15 mm in a 23° C. temperature region and not less than 5 N/15 mm and not more than 25 N/15 mm in a 90° C. temperature region.

The food packaging bag according to the present invention is also characterized in that at least one wide seal part is provided in the peripheral part in said packaging bag.

The food packaging bag according to the present invention is also characterized by comprising at least a front laminated film, a rear laminated film, and a bottom laminated film and is a self-supporting packaging bag.

The food packaging bag according to the present invention is also characterized in that a print is provided on said front laminated film and said rear laminated film and said bottom laminated film is transparent and can see the contents of said bag therethrough.

The food packaging bag according to the present invention is also characterized by further comprising a fastener or a zipper that can again close said packaging bag.

According to another aspect of the present invention, there is provided a food-packaged body characterized by consisting essentially of the above packaging bag and a food which has been packed and hermetically sealed in said packaging bag.

According to a further aspect of the present invention, there is provided a method for manufacturing a food-packaged body, characterized by comprising the steps of:
(a) providing a laminated film comprising at least a base layer and a sealant layer and folding back or superimposing said laminated film in such a manner that said sealant layer faces inward;
(b) bonding the edge while leaving a food packing opening to form a packaging bag;
(c) forming a point seal part within said packaging bag, connected to or independently of said edge;
(d) forming an easy-vapor-passing part provided in the area of said point seal part;
(e) packing a food into said packaging bag; and
(f) after said step (e), hermetically sealing said packaging bag,
said steps (b) to (d) being carried out in any desired order after said step (a) and being followed by said step (e) and said step (f).

The method for manufacturing a food-packaged body according to the present invention is also characterized in that said food is cooked rice prepared by washing rice, immersing the washed rice in water, draining the rice, and cooking and steaming the rice, or cooked rice prepared by washing rice and either cooking and steaming the rice or immersing the rice in hot water, then immersing the rice in cold water, and either blowing air against the rice or allowing the rice to cool at room temperature.

The method for manufacturing a food-packaged body according to the present invention is also characterized by further comprising (g) the step of packing said food into said packaging bag, hermetically sealing the packaging bag, and then subjecting the bag to retort sterilization.

The method for manufacturing a food-packaged body according to the present invention is also characterized in that at least one of water, ingredients, flavoring materials, and fats and oils is added to said food.

The packaging body according to the present invention can be used for hermetical sealing of retort foods for long-term storage at room temperature. Thus, the present invention can provide a food packaging bag for a microwave oven that can be sealed with high productivity, permits foods to be easily packed therein, does not undergo breakage of the seal upon exposure to pressure or impact applied during transport or storage, and, even when heated in the hermetically sealed state in a microwave oven, permits steam within the packaged body to be rapidly discharged to automatically lower the internal pressure, can prevent retort foods from spilling, can realize cooking in a safe manner, enables excessive steam to be automatically discharged to the outside of the bag, can provide nonsticky, non-mealy, delicious foods, enables the contents after heating in a microwave oven to be safely taken out of the bag, and is also excellent in display effect at the store, and a method for manufacturing a food-packaged body.

### BRIEF DESCRIPTION OF THE DRAWINGS

FIG. 1 is a perspective view showing an embodiment of the packaging bag according to the present invention;

FIG. 2A is an explanatory view illustrating a position, in the packaging bag according to the present invention, where a point seal part is formed;

FIG. 2B is an explanatory view illustrating a position, in the packaging bag according to another embodiment of the present invention, where a point seal part is formed;

FIG. 3 is an explanatory view illustrating the form of a point seal part;

FIG. 4 is an explanatory view illustrating the form of an easy-vapor-passing part formed within an unseal part surrounded by a point seal part;

FIG. 5 is a cross-sectional view taken on line V-V of FIG. 1;

FIG. 6A is a cross-sectional view of a laminated film for constituting the packaging bag according to the present invention;

FIG. 6B is a cross-sectional view of a laminated film for constituting the packaging bag in another embodiment of the present invention;

FIG. 7A is an explanatory view illustrating the form of a holding part provided in a peripheral heat seal part in the packaging bag according to the present invention;

FIG. 7B is an explanatory view illustrating the form of a holding part provided in a peripheral heat seal part in the packaging bag in another embodiment of the present invention;

FIG. 8 is a perspective view of an embodiment of a packaging bag with a zipper according to the present invention;

FIG. 9A is a diagram showing an embodiment of the construction of a laminated film for constituting the packaging bag according to the present invention;

FIG. 9B is a diagram showing another embodiment of the construction of a laminated film for constituting the packaging bag according to the present invention; and

FIG. 9C is a diagram showing a further embodiment of the construction of a laminated film for constituting the packaging bag according to the present invention.

### BEST MODE FOR CARRYING OUT THE INVENTION

The present invention will be described in more detail with reference to the following preferred embodiments.

Features of Packaging Body

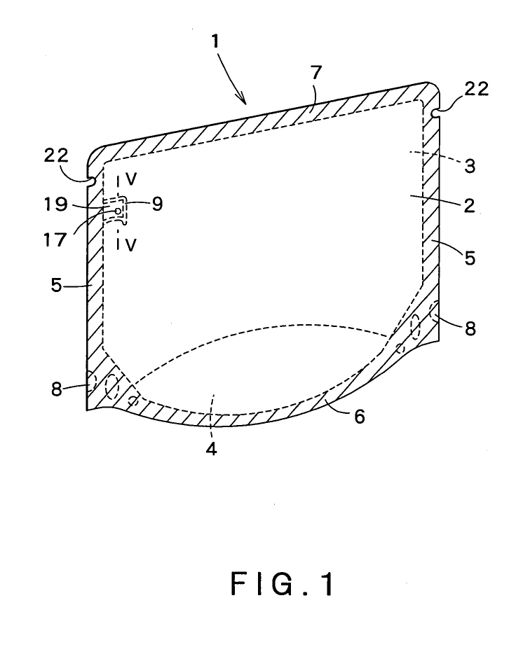

FIG. 1 shows a packaging body 1 in a preferred embodiment of the present invention. In this packaging body 1, a peripheral seal part, that is, a part including a top seal part 7, a body seal part 5, and a bottom seal part 6, is provided for bag hermetical sealing purposes. A point seal part 9 is provided for permitting steam produced upon heating in a microwave oven from escaping from the bag. When the packaging body according to the present invention is heated in a food packaged state in a microwave oven, as soon as the point seal part 9 is peeled outward and the peeled part reaches an unseal part 19, steam is rapidly and stably discharged through an easy-vapor-passing part 17 provided in the area of the unseal part 19. Therefore, for example, there is no need to previously cut a part of the bag with scissors or the like for preventing the burst of the packaging body.

Point Seal Part

The point seal part 9 provided in the packaging body 1 according to the present invention as shown in FIG. 1 may be provided independently of the peripheral seal part such as the body seal part 5 and the top seal part 7. However, the provision of the point seal part 9 connected to the peripheral seal part is preferred because, upon heating in a microwave oven, the pressure application site is mainly limited to the point seal part 9. In this case, upon the peeling of the seal from the edge of the point seal part 9, steam produced from contents such as foods is passed through the easy-vapor-passing part 17 or the like provided within the unseal part 19 and is rapidly discharged to the outside of the bag. Further, the formation of the point seal part connected to the peripheral seal part can advantageously eliminate the need to form the body seal part 5 or the top seal part 7 and the point seal part 9 in two stages, and the body seal part 5 or the top seal part 7 and the point seal part 9 can be formed integrally with good productivity.

The formation of the unseal part 19 surrounded by the point seal part 9 has the following advantage over the case where the unseal part 19 is not formed. Specifically, the position of the easy-vapor-passing part formed in the unseal part 19 may be deviated from a predetermined position. Since the distance of the outward peeling of the seal is constant and, upon peeling of the seal to a position in the unseal part 19, the easy-vapor-passing part formed in the unseal part 19 can be opened widely at once, when the packaging body in a food packaged state is heated, steam can be surely and rapidly discharged from the bag in a stable manner. When only solid seal is provided without providing the unseal part 19 surrounded by the point seal part 9, the deviation of the position of the easy-vapor-passing part 17 formed from the desired position causes a change in a seal peel distance which disadvantageously makes it impossible to always realize stable seal peeling. Further, since the easy-vapor-passing part 17 is located in an area surrounded by the point seal part 9 and the body seal part 5 and the top seal part 7, the hermetical sealing properties can be fully kept during the course of distribution of the food packaged body. This is hygienically advantageous.

<Position of Point Seal Part>

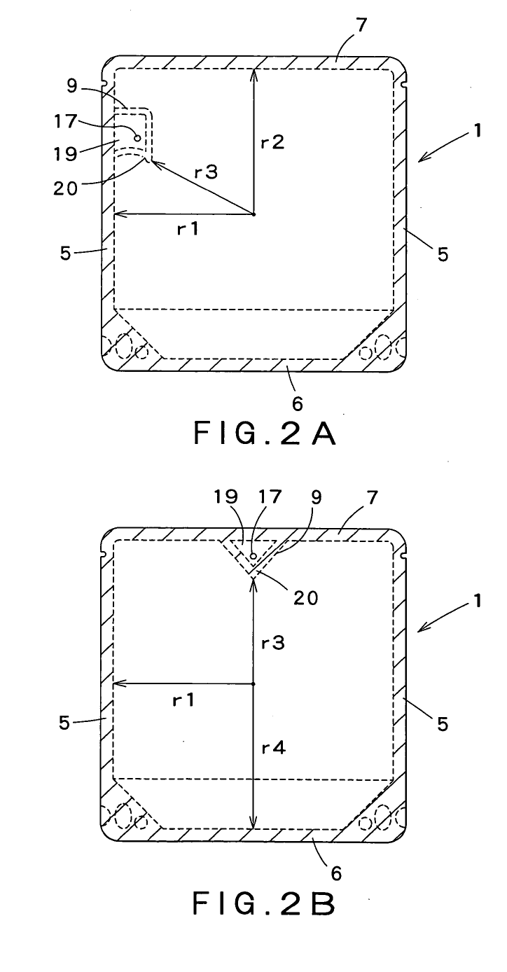

As shown in FIG. 2A, the position of the point seal part 9 formed is preferably such that, when circles are drawn about the center part of the packaging bag, the radius r3 of the circle in contact with the lowermost end of the point seal part 9 from the center of the packaging body 1 is smaller than the radius r1 of the circle in contact with the inner edge of the body seal part 5 or the radius r2 of the circle in contact with the inner edge of the top seal part 7. When the radius r3 is larger than the radius r1 or the radius r2, the outward peeling of the seal part caused by heat of steam produced upon heating and a rise in internal pressure derived from the steam takes place in the body seal part 5 or the top seal part 7 in the packaging bag, often disadvantageously resulting in the burst of the packaging bag and, in its turn, leakage of the contents.

When the point seal part 9 is formed as shown in FIG. 2B, the position of the point seal part 9 is preferably such that, when circles are drawn about the center part of the packaging bag, the radius r3 of the circle in contact with the lowermost end of the point seal part 9 from the center of the packaging body 1 is smaller than the radius r1 of the circle in contact with the inner edge of the body seal part 5 or the radius r4 of the circle in contact with the inner edge of the bottom seal part 6. When the radius r3 is larger than the radius r1 or the radius r4, the outward peeling of the seal part caused by heat of steam produced upon heating and a rise in internal pressure derived from the steam takes place in the body seal part 5 or the bottom seal part 6 in the packaging bag, often disadvantageously resulting in the burst of the packaging bag and, in its turn, leakage of the contents.

From the viewpoint of easy packing of the contents, the point seal part 9 may be formed at a position deviated from the center part.

In the present invention, as shown in FIGS. 1, 2A, and 2B, the point seal part is formed so as to be located at a position above foods packed in the bag in such a state that the packaging bag is self-supported.

<Form of Point Seal Part>

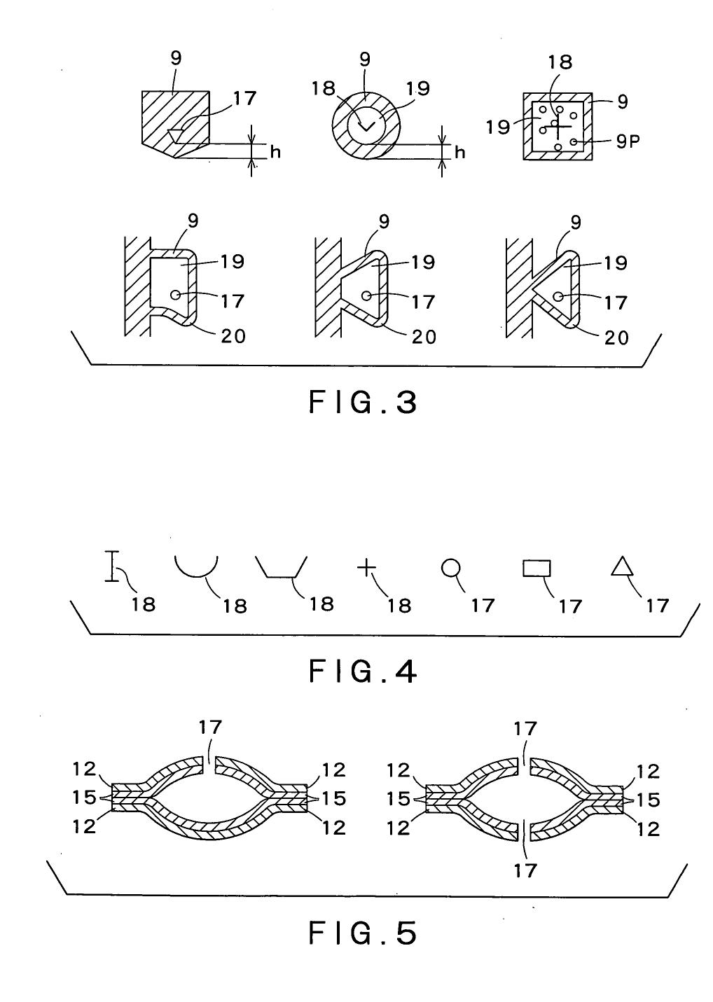

The form of the point seal part 9 may be, for example, as shown in FIG. 3. More preferably, as shown in the lower part of FIG. 3, a protruded end 20 which is the protruded lowermost end of the seal part is provided. The form of the point seal part is not limited so far as the protruded end 20 is formed, and examples thereof include horseshoe-form, trapezoidal form, and triangular form. By virtue of this construction, the internal pressure applied upon heating is likely to be concentrated on the protruded end, and, thus, the seal part can be surely and smoothly peeled outward with the protruded end 20 as the starting point. This is advantageously safe and thus is preferred.

The seal width of the point seal part 9 is preferably about 2 mm to 5 mm because the seal can be smoothly peeled by the internal pressure produced upon heating. When the seal width of the point seal part 9 is less than 2 mm, the seal strength is disadvantageously unstable. On the other hand, when the seal width exceeds 5 mm, the peeling of the seal by the internal pressure produced upon heating is not disadvantageously smooth.

A patterned seal part 9P may be formed in the point seal part. The form of the patterned seal is not particularly limited, and examples thereof include mesh, stripe, lattice, and dot forms.

On the other hand, when the seal width of the peripheral seal part, that is, the body seal part 5, the bottom seal part 6, and the top seal part 7 in the packaging body 1 in FIG. 1 is preferably about 5 mm to 20 mm from the viewpoint of preventing breakage of the bag due to pressure and impact applied during transport and storage and during heating.

<Easy-Vapor-Passing Part>

FIG. 4 shows examples of the form of a notch 17 or a cut 18 as the easy-vapor-passing part formed in the unseal part 19 surrounded by the point seal part 9. Specifically, the cut 18 may be, for example, in an I-shaped, U-shaped, cross, or V-shaped form, and the notch 17 may be, for example, in a circular, quadrangular, triangular, or elliptical form.

The number of notches 17 or cuts 18 is not limited to one but may be plural. When the notch 17 or the cut 18 is formed, steam filling the bag is diffused from the seal peel part at the lowermost end of the peeled point seal part 9 through the notch 17 or the cut 18 provided in the unseal part 19 into the outside of the bag. Therefore, the internal pressure of the bag can be lowered to avoid the burst of the packaging bag.

As shown in FIG. 5, the notch 17 or the cut 18 as the easy-vapor-passing part formed in the point seal part 9 or the unseal part in the point seal part may be provided so as to extend through the two members constituting the opposed body part, or alternatively the notch 17 or the cut 18 may be provided in only one side of the bag. The notch 17 or the cut 18 may be formed, for example, by laser beam machining or punching.

The distance between the lowermost end of the notch or cut formed in the point seal part 9 and the lower end of the point seal part is preferably in the range of 2 to 10 mm, more preferably in the range of 3 to 5 mm. This construction is advantageous in that the bag is not broken upon exposure to external impact during the course of distribution of the food-packaged body according to the present invention and, during heating in a microwave oven, outward peeling of the seal can rapidly take place due to steam generated upon heating at the point seal part to discharge steam. When the distance between the notch or the cut and the point seal part is less than 2 mm, disadvantageously, satisfactory seal strength cannot be ensured during the course of distribution. On the other hand, when the distance between the notch or the cut and the point seal part exceeds 10 mm, disadvantageously, outward peeling does not smoothly occur upon heating in a microwave oven.

Laminated Film

<Structure>

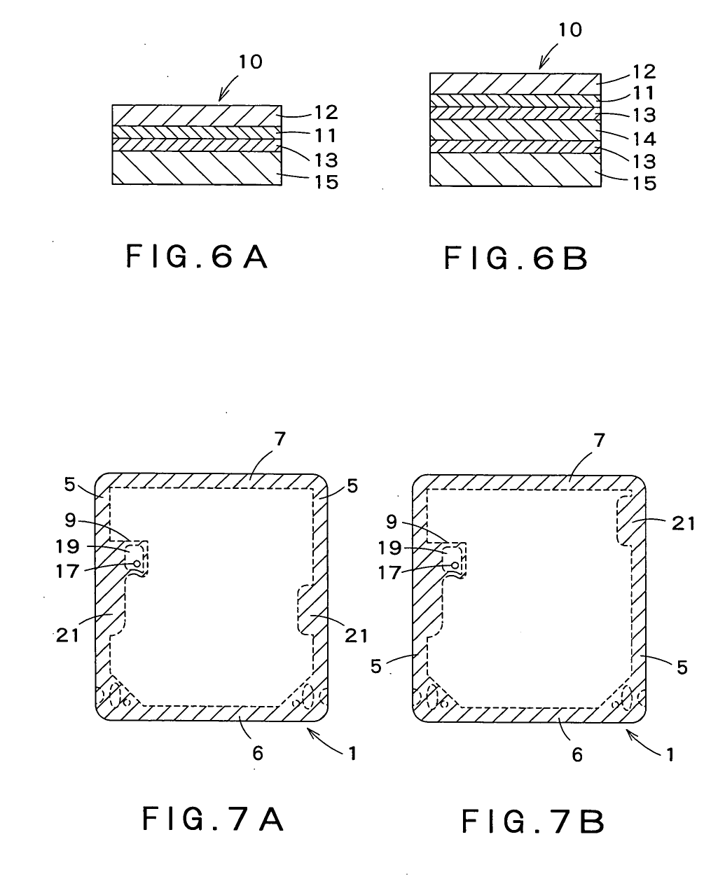

For example, as shown in FIG. 6A, a laminated film 10 for constituting the packaging bag for a microwave oven according to the present invention includes a base layer 12, a print layer 11, an adhesive layer 13, and a sealant layer 15 stacked on top of one another. Further, for example, as shown in FIG. 6B, if necessary, an intermediate layer 14 may be interposed between the base layer 12 and the sealant layer 15. The print layer 11 and the adhesive layer 13 are layers which are not indispensable and may be optionally provided according to need.

Next, materials for constituting the laminated film 10 constituting the packaging body according to the present invention will be described.

<Base Layer>

At the outset, the base layer 12 may be formed of any material that has heat resistance and is commonly used as a food packaging material for use in heating or cooking in a microwave oven without particular limitation. Examples of such materials include: stretched polyethylene terephthalate films; silica-deposited stretched polyethylene terephthalate films; alumina-deposited stretched polyethylene terephthalate films; stretched nylon films; silica-deposited stretched nylon films; alumina-deposited stretched nylon films; stretched polypropylene films; polyvinyl alcohol-coated stretched polypropylene films; nylon 6/methaxylylene diamine nylon 6 co-extrusion co-stretched films; and polypropylene/ethylene-vinyl alcohol copolymer co-extrusion co-stretched films or the like. The base layer 12 may be formed of any one of the above films, or alternatively may be formed of a laminated film comprising two or more films of the above materials stacked on top of each other. That is, the base layer may have a single layer or multilayer (laminate) structure, has a heat resistance of 150° C. or above in terms of melting point, and preferably has a thickness of 10 to 50 μm, more preferably about 10 to 30 μm.

<Sealant Layer>

In the present invention, the resin for constituting the sealant layer 15 is not particularly limited so far as the resin is commonly used as a food packaging material in the form of a heat-sensitive adhesive resin layer for heating or cooking in a microwave oven and has a seal strength of not more than 25 N/15 mm at a temperature of 90° C. or above and not less than 23 N/15 mm at room temperature (23° C.).

The seal strength is preferably 5 N/15 mm to 25 N/15 mm, more preferably 10 N/15 mm to 15 N/15 mm, at a temperature of 90° C. or above. When the seal strength exceeds 25 N/15 mm at a temperature of 90° C. or above, the outward peeling of the seal does not smoothly occur and, thus, disadvantageously, there is a possibility that automatic opening cannot be rapidly and surely achieved and, in some cases, the burst of the bag occurs. The seal strength at room temperature (23° C.) should be not less than 23 N/15 mm for severe retort sterilization of the food-packaged bag for a microwave oven and is more preferably not less than 30 N/15 mm from the viewpoint of avoiding breakage of the seal upon falling or vibration during transport or storage.

The state of unsealing is not particularly limited. However, cohesive failure is preferred. The seal strength of the point seal part may be lower than that of the other seal parts, that is, the body seal part 5, the bottom seal part 6, and the top seal part 7. In this connection, it should be noted that, even when the seal strength of the point seal part is the same as that of the other seal parts, automatic unsealing can be achieved so far as the form of the point seal part is as described above.

Examples of resins usable for constituting the sealant layer 15 include low-density polyethylene, linear low-density polyethylene, intermediate-density polyethylene, high-density polyethylene, polypropylene, propylene-ethylene copolymer, ethylene-vinyl acetate copolymer, ethylene-acrylic acid copolymer, ethylene-methacrylic acid copolymer, ethylene-methylacrylate copolymer, ethylene-ethylacrylate copolymer, ethylene-methylmethacrylate copolymer, or ionomers.

Among them, a resin composition composed mainly of a propylene-ethylene block copolymer resin is preferred. When a mixed resin is used, the mixed resin preferably comprises a propylene-ethylene block copolymer (A) as the first component, a propylene-ethylene block copolymer (B) as the second component, and an ethylene-butene-1 copolymer having a butene-1 content of not less than 15% by weight as the third component. The propylene-ethylene block copolymer (A) as the first component comprises 65 to 85% by weight of a propylene block (I) comprising a propylene homopolymer or a propylene-ethylene copolymer having an ethylene content of not more than 2% by weight, and 15 to 35% by weight of an ethylene-propylene copolymer block (II) having an ethylene content of 20 to 95% by weight. The propylene-ethylene block copolymer (B) as the second component comprises 85 to 95% by weight of a propylene block (III) comprising a propylene homopolymer or a propylene-ethylene copolymer having an ethylene content of not more than 2% by weight and 5 to 15% by weight of an ethylene-propylene copolymer block (IV) having an ethylene content of 20 to 95% by weight.

The sealant layer may be formed by extrusion lamination of these resins, or alternatively, a method may also be adopted in which a film is first formed by a T die method, an inflation method or the like and is then laminated onto the heat-resistant base layer by a dry lamination method, an extrusion lamination method or the like.

The thickness of the sealant layer is preferably about 20 to 100 μm, more preferably 40 to 70 μm.

<Adhesive Layer>

In the present invention, an adhesive layer 13 may be provided between the base layer 12 and the sealant layer 15. The adhesive layer 13 is a lamination adhesive or an adhesive resin layer.

Examples of lamination adhesives usable herein include one-component or two-component curable or noncurable type vinyl, (meth)acrylic, polyamide, polyester, polyether, polyurethane, epoxy, rubber, and other lamination adhesives which may be of solvent, aqueous, emulsion or other type. The lamination adhesive may be coated, for example, by direct gravure roll coating, gravure roll coating, kiss coating, reverse roll coating, fountain coating, or transfer roll coating. The coverage of the lamination adhesive is preferably about 0.1 to 10 g/m² on a dry basis, more preferably about 1 to 5 g/m² on a dry basis.

The adhesive resin layer may be a resin layer of a thermoplastic resin which may be used for adhesion between layers. Specific examples of materials for the adhesive resin layer include low-density polyethylene resin, intermediate-density polyethylene resin, high-density polyethylene resin, straight-chained low-density polyethylene resin, ethylene-α olefin copolymer resin produced by polymerization in the presence of a metallocene catalyst, ethylene-polypropylene copolymer resin, ethylene-vinyl acetate copolymer resin, ethylene-acrylic acid copolymer resin, ethylene-ethyl acrylate copolymer resin, ethylene-methacrylic acid copolymer resin, ethylene-methyl methacrylate copolymer resin, ethylene-maleic acid copolymer resin, ionomer resin, resins produced by graft polymerization or copolymerization between polyolefin resin and an unsaturated carboxylic acid, an unsaturated carboxylic acid, an unsaturated carboxylic anhydride, or an ester monomer, and resins modified by grafting maleic anhydride onto polyolefin resin. These materials may be used alone or in a combination of two or more. The thickness of the resin layer is preferably about 10 to 30 μm.

<Intermediate Layer>

In the present invention, an intermediate layer 14 may be provided between the base layer 12 and the sealant layer 15. The intermediate layer 14 is generally provided, for example, when the provision of only the base layer 12 and the sealant layer 15 do not suffice for functions as the packaging body 1. Such functions include gas barrier properties, mechanical toughness, flex resistance, piercing resistance, impact resistance, abrasion resistance, cold resistance, heat resistance, and chemical resistance. These functions required of the packaging bag can be achieved by providing the intermediate layer 14.

Examples of base materials used as the intermediate layer 14 include: films of polyolefins such as polyethylene terephthalate, polyamide, polyethylene, and polypropylene, polyvinyl chloride, polycarbonate, polyvinyl alcohol, ethylene-propylene copolymer, and ethylene-vinyl acetate copolymer saponification products; films formed by coating polyvinylidene chloride onto the above films; films formed by vapor depositing an inorganic material such as silicon oxide or aluminum oxide onto the above films; and films of polyvinylidene chloride. These base materials may be used alone or in a combination of two or more. The thickness of the base material is not particularly limited and may be properly selected so that functions required of the packaging body can be provided.

<Lamination>

The lamination of the base layer 12 onto the sealant layer 15 may be carried out by any method without particular limitation, for example, by coextrusion lamination or dry lamination.

If necessary, pretreatment, for example, corona treatment, ozone treatment, or flame treatment, may be carried out before the lamination. The surface pretreatment is carried out for improving adhesion or the like in the lamination of each layer onto various resin film or sheets. Alternatively, in order to improve the adhesion, for example, a primer coating agent layer, an undercoating agent layer, or an anchor coating agent layer may be optionally previously formed as a surface treatment layer on the surface of various resin films or sheets. When a print layer is provided, a conventional print layer commonly used in food packaging bags for retort use or the like may be used.

Form of Packaging Body

<Typical Form>

The packaging body of the present invention may be, for example, in a form as shown in FIG. 1. Specifically, a laminated film for a packaging bag is provided. Two wall surface laminated films respectively for a front face 2 and a back face 3 in a body are prepared from the laminated film. Edge parts on both sides of the two laminated films are heat sealed at a body seal part 5. A point seal part 9 is integrally provided independently of or in connection with the body seal part 5 on at least one side of the wall surface laminated film. At least one easy-vapor-passing part 17 is provided in an unseal part 19 surrounded by the point seal part 9. Thereafter, a bottom face 4 is brought to a gusset form by folding the film inward. A bottom seal part 6 may be formed by heat sealing in a ship's bottom-type seal pattern. After packing of a food into the bag, the upper end may be sealed to form a top seal part 7.

<Form of Seal>

The packaging bag according to the present invention may be a bag that is, for example, in a lateral seal form, a two-way seal form, a three-way seal form, an envelope sticking seal form, a center butt seal form (a pillow seal form), a ribbed seal form, a flat bottom seal form, a square bottom seal form, a stand pouch seal form, or a wing seal form. Here the wing seal-type bag refers to a packaging bag prepared by disposing a lower member with a sealant surface as an upper surface, allowing sealant surfaces to face each other, sealing the side part and the front edge part to form a wing part, superimposing an upper member with a sealant surface as an lower surface on the above member, and sealing the peripheral part to form a main seal part for hermetical sealing.

<Self-Supporting Properties>

When the packaging body according to the present invention is in a self-supportable packaging form, heating in a microwave oven can be carried out in such a state that the packaging bag is self-supported. Therefore, advantageously, a consumer can easily take the bag out of the microwave oven in a safe manner, and retort foods contained in the food-packaged body can easily be taken out to the outside of the bag. Further, when the food contained in the bag is served, preferably, the packaging bag as such can be used as a container without opening the upper part to serve the food to a container or the like.

The height of the packaging bag is preferably not more than 160 mm from the viewpoint of taking the bag out of the microwave oven. When the height of the packaging bag exceeds 160 mm, disadvantageously, the bag gets stuck with ceiling within the microwave oven and, in some cases, is overturned during rotation.

Regarding the outer dimension of the packaging bag, the width of the packaging bag is preferably larger than the height of the packaging bag because the packaged body can be stably self-supported.

<Notch>

In the packaging body according to the present invention, a notch 22 is preferably provided at the edge of the body seal part 5 in the bag. In this case, the use of a stretched film, which can easily be torn in a lateral direction through the notch 22, is preferred.

<Holding Part>

The holding part, which may be formed in the packaging body according to the present invention, as shown in FIGS. 7A and 7B, is formed by forming a large-width seal part in the body seal part 5 or the top seal part 7. Preferably, the holding part 21 is formed at a position not on the upper side of the point seal part. For example, at least one holding part is preferably formed on the lower side of the point seal part 9 or in the body seal part 5 or the top seal part 7 where the point seal part 9 is not formed. This construction is advantageous in that, when the bag is taken out of the microwave oven after heating in the microwave oven, the consumer can safely take out the bag without causing burning by steam released from the easy-vapor-passing part 17 in the point seal part 9. Further, since the large-width part is not hotter than the surface part of the film in the bag in contact with the contents, the bag can be reliably taken out in a safe manner. The seal width of the large-width seal part is preferably about 10 to 20 mm from the viewpoint of taking the bag out of the microwave oven reliably and safely after heating in the microwave oven.

<Fastener or Zipper>

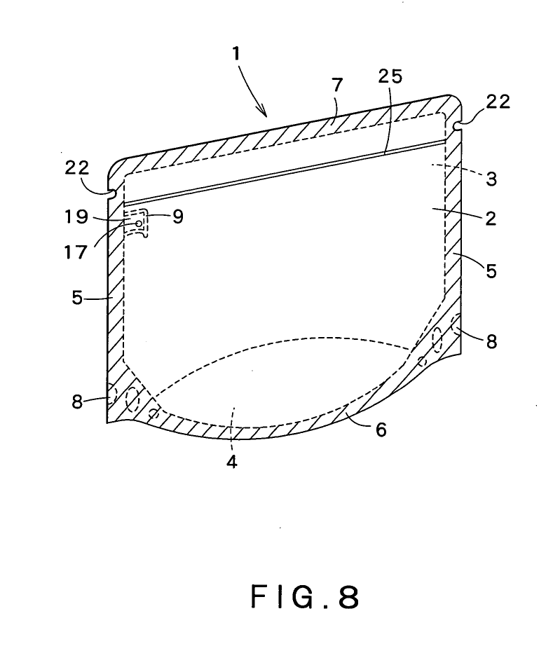

In the packaging body according to the present invention, as shown in FIG. 8, a fastener or a zipper 25 can be provided so that the once opened bag can be reclosed. This can facilitate temporary storage of the food contained in the packaged body after one opening the packaged body.

Foods

Foods, preferably cooked rices, are filled and packed into the packaging body according to the present invention.

Cooked rices include cooked white rice, Gomokumeshi (Japanese pilaf), Sekihan (steamed rice mixed with red beans), pilaf, fried rice, chicken and rice, rice gruel or porridge, and porridge of rice and vegetables. Not only rices but also raw wheats such as barley, rolled barley, ground barley, and wheat may be used.

Regarding uncooked rices used in the present invention, production districts, kinds, quality and the like are not limited. For example, production districts may be any of Japan, China, Thailand and the like. Regarding the kind of the rice, any of the so-called “japonica rice”, “indica rice” and the like may be used. In the case of the so-called “Japanese-style cooked rice” such as Gomokumeshi and Sekihan, the use of japonica rice is more preferred because, upon heating in a microwave oven, cooked rice, which is suitably sticky and suits Japanese taste, can be prepared. On the other hand, in the case of the so-called “western-style cooked rice” such as pilaf, the use of indica rice is more preferred because, after heating in a microwave oven, cooked rice, which has mealy appearance and sense of taste, can be prepared.

In the present invention, the retort cooked rice may be prepared, for example, by washing uncooked rice, immersing the washed rice in water for about 30 min to 2 hr, draining the rice, heating and steaming the rice at 100° C. for 3 to 5 min, packing the heated and steamed rice into the above packaging bag for a microwave oven, hermetically sealing the bag, and then subjecting the bag to retort sterilization. On the other hand, the retort cooked rice such as pilaf may be prepared, for example, by washing uncooked rice, draining the washed rice, either heating and steaming the rice at 100° C. for 3 to 5 min, or immersing the washed rice in hot water at 100° C. for 5 to 10 min, then subjecting the rice to cooling treatment by immersing the rice in cold water or allowing the rice to cool while air blowing or at room temperature to a rice temperature of 40° C. or below, then packing the cooked rice into the bag, hermetically sealing the bag, then placing the bag, for example, in a retort sterilizer, and subjecting the bag to retort treatment under conditions of temperature 200° C., pressure 2 kg/cm², and 20 to 40 min. The retort sterilizer may be a hot water-type retort sterilizer, a steam-type retort sterilizer, a shower-type retort sterilizer, or a spray-type retort sterilizer.

Foods other than cooked rices which can be packed into the packaging body according to the present invention include foods such as beans, chestnuts, corms, and pickles, fish and seafood, flavoring materials, spices such as curry powder and saffron, water, soup stock, and vegetable oils.

Method for Manufacturing Food-Packaged Body

In manufacturing the food-packaged body according to the present invention, (a) a laminated film comprising at least a base layer and a sealant layer is folded back or superimposed in such a manner that the sealant layer faces inward. Thereafter, (b) the step of bonding the edge while leaving a cooked rice packing opening to form a packaging bag, (c) the step of forming a point seal part within said packaging bag, connected to or independently of said edge, and (d) the step of forming an easy-vapor-passing part provided within said point seal part are carried out in a desired order. Next, (e) the step of packing a cooked rice into said packaging bag, and (f) the step of, after the above packing, hermetically sealing said packaging bag are carried out.

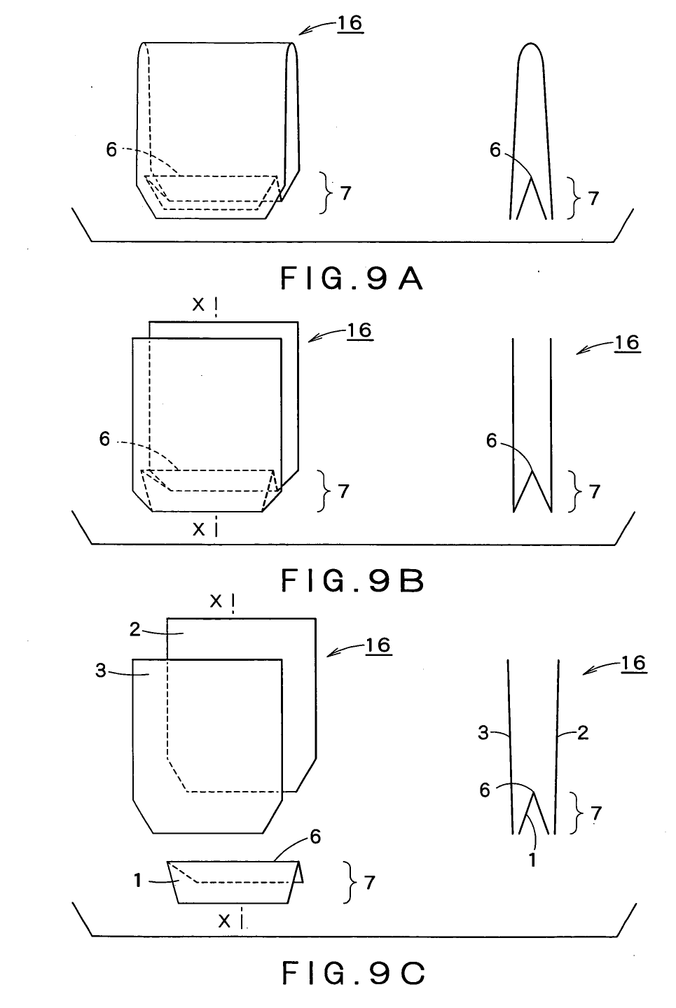

In the food-packaging body according to the present invention, specific construction and formation procedure of the laminated film in the formation of the packaging bag are shown in FIG. 9A. As shown in FIG. 9A, the laminated film is folded back in such a manner that the sealant layer faces inward. In the folded laminated films on both sides, one of the laminated film is folded back in such a manner that the sealant layer faces inward to form a gusset part having a folded bag-shaped folded-back part on its inner side which is used as a bottom part. Ends of the folded composite films on both sides are superimposed on top of each other at one bottom part, and a notch of a right-angle triangle having right-angle two sides of lower side and corner in the body part and the bottom part is formed bilaterally-symmetrically. In addition, while leaving one side part, the edge is heat bonded, and the other side part is left as a packing opening for contents. Thus, a packaging bag is prepared. A steam vent means is provided separately from or in connection with the heat bonded part at the top part. This packaging bag can be self-supported by opening the gusset part at the bottom part.

A packaging bag in another embodiment of the present invention may be formed as shown in FIG. 9B. As shown in FIG. 9B, the laminated film is folded back in such a manner that the sealant layer faces inward. The folded part is further folded back so that the sealant layer faces inward to form a gusset part having a folded bag-shaped folded-back part on its inner side which is used as a bottom part. Ends of the folded composite films on both sides are superimposed on top of each other at the top part, and a notch of a right-angle triangle having right-angle two sides of lower side and corner in the body part and the bottom part is formed bilaterally-symmetrically. In addition, while leaving one side part, the edge is heat bonded, and the other side part is left as a packing opening for contents. Thus, a packaging bag is prepared. A steam vent means is provided separately from or in connection with the heat bonded part at the top part. This packaging bag can also be self-supported by opening the gusset part at the bottom part.

A packaging bag in a further embodiment of the present invention may be formed as shown in FIG. 9C. As shown in FIG. 9C, opposed front and back body members are so that the sealant layer of the laminated film faces inward. The laminated film is folded back so that the sealant layer faces inward to form a bottom material having a folded bag-shaped folded-back part on its inner side which is then inserted into the bottom part of the body members to form a gusset part. A notch of a right-angle triangle having right-angle two sides of lower side and corner of the body members and the bottom material is formed bilaterally-symmetrically. In addition, while leaving one side part, the edge is heat bonded, and the other side part is left as a packing opening for contents. Thus, a packaging bag is prepared. A steam vent means is provided separately from or in connection with the heat bonded part at the top part. This packaging bag can also be self-supported by opening the gusset part at the bottom part.

In the formation of the packaging bag in a further embodiment of the present invention, quadrangular front and back body members are provided. The laminated film is folded back in a inverted V-shaped form to constitute a bottom face which is then inserted into the bottom part of the body members. The peripheral part of the front face and the back face and the bottom face is heat sealed to form a top seal part, a body seal part, and a bottom seal part. Thus, a self-supportable bag is formed in which the bottom part is widened by the filled contents backward and forward to self-support the bag. A horseshoe-shaped seal part is provided in connection with the top seal part or the body seal part, and at least one cut or notch is provided in the unseal part surrounded by the horseshoe-shaped seal part.

Heat sealing may be carried out by conventional methods, for example, bar sealing, rotary roll sealing, belt sealing, impulse sealing, high-frequency sealing, or ultrasonic sealing.

Heating in Microwave Oven

In cooking of the food-packaged body according to the present invention in a microwave oven for a predetermined period of time, even when the hermetically sealed packaged body as such is heated in a self-supported state, steam generated within the packaging bag can be rapidly discharged through the easy-vapor-passing part formed in the packaging bag to automatically lower the internal pressure. Therefore, heating or cooking can be safely carried out. Further, the formation of a holding part in the packaging bag is advantageous in that the consumer can take the heated or cooked packaged body out of the microwave oven in a safe manner without causing burning. Furthermore, the cooked rice can be served on a dish in an easy and safe manner, and, for example, cooked rice, which has no hard center and has absorbed a satisfactory amount of water, or a pilaf having mealy sense of taste can be produced.

### EXAMPLES

The following Examples and Comparative Examples further illustrate the present invention.

### Example 1-1

A 12 μm-thick silica-deposited biaxially stretched polyethylene terephthalate film, a 15 μm-thick biaxially stretched nylon film, and a 60 μm-thick unstretched polypropylene film were dry laminated on top of one another with the aid of a two-pack curable urethane adhesive to prepare a laminated film having a layer construction of silica-deposited biaxially stretched polyethylene terephthalate film layer (substrate film layer)/urethane adhesive layer (adhesive layer)/biaxially stretched nylon film layer (intermediate layer)/urethane adhesive layer (adhesive layer)/unstretched polypropylene film (sealant layer). Next, the laminated film was cut at its desired position, and, as shown in FIG. 2B, a bag body part was prepared by heat-fusing the cut laminated film at its top seal part and side seal part and folding the heat-fused laminated film. A point seal part 9 connected to the edge of the top part was provided. At least one notch 17 was provided in the unsealed part in the area of the point seal part 9 to form a vapor vent means, followed by heat fusing at its predetermined position. Thus, a packaging bag, for a microwave oven, having a point seal part 9 according to the present invention (outer dimension: height 150 mm, width 160 mm) as shown in FIG. 2 was prepared.

Ordinary rice was provided as uncooked rice. The rice was washed, was immersed in water, was drained, and was then cooked and steamed at 100° C. for 3 min. Thereafter, 130 g of the cooked and steamed rice, 92 g of water, and 3 g of a vegetable oil were packed into the packaging bag for a microwave oven. The top seal part was sealed to hermetically seal the bag, and the bag was then subjected to retort sterilization at 120° C. for 30 min to prepare a food packaged body according to the present invention.

The food packaged body thus obtained was heated in a self-supported state in a 700-W microwave oven for 2.5 min. As a result, the food packaged body was stably and satisfactorily cooked on a tray being rotated within the microwave oven without overturning. About 1 min 40 sec after the initiation of cooking, steam was quickly vented through the notch. Thus, satisfactorily water absorbed cooked rice without a hard center could be obtained without boiling-over of the contents of the packaged body.

### Example 1-2

Nonglutinous rice was provided as uncooked rice. The rice was washed, was immersed in water, was drained, and was then cooked and steamed at 100° C. for 5 min. Thereafter, the cooked and steamed rice was immersed in cold water of 15° C. for one min and was then cooled. 180 g of the cooked and steamed and cooled rice, 45 g of water, 15 g of an onion, 2 g of salt, 5 g of a sunflower seed oil, and curry powder were packed into the packaging bag prepared in Example 1-1. The top seal part was sealed to hermetically seal the bag, and the bag was then subjected to retort sterilization at 120° C. for 40 min to prepare a food packaged body according to the present invention.

The food packaged body for a microwave oven thus obtained was heated in a self-supported state in a 500-W microwave oven for 2.5 min. As a result, the food packaged body was stably and satisfactorily cooked on a tray being rotated within the microwave oven without overturning. About 1 min 40 sec after the initiation of cooking, steam was quickly vented through the notch. Thus, curryied rice which is nonsticky and has mealy sense of taste could be obtained without boiling-over of the contents of the packaged body.

### Example 2-1

A 12 μm-thick alumina-deposited biaxially stretched polyethylene terephthalate film, a 15 μm-thick biaxially stretched nylon film, and a 70 μm-thick unstretched polypropylene film were dry laminated on top of each other with the aid of a urethane adhesive to prepare a laminated film having a layer construction of alumina-deposited biaxially stretched polyethylene terephthalate film layer (substrate film layer)/urethane adhesive layer (adhesive layer)/biaxially stretched nylon film layer (intermediate layer)/urethane adhesive layer (adhesive layer)/unstretched polypropylene film (sealant layer).

Next, the laminated film was cut at its desired position, and, as shown in FIG. 2B, a bag body part was prepared by heat-fusing the cut laminated film at its top seal part 7 and side seal part 5 and folding the heat-fused laminated film. A point seal part 9 connected to the edge of the top part was provided. Notch 17 was provided in the unseal part 19 within the point seal part 9 to form a vapor vent means, followed by heat fusing at its predetermined position. Thus, a packaging bag according to the present invention was prepared.

As shown in FIG. 2B, the point seal part 9 was provided at such a position that, when circles were drawn about the center part of the packaging bag body, the radius r3 of the circle in contact with the lowermost end of the point seal part 5 from the center of the packaging bag was 50 mm, the radius r1 of the circle in contact with the inner edge of the side seal part 5 was 70 mm, and the radius r1 was smaller than the radius r4.

This packaging bag had excellent suitability for packing of the contents because the contents can be packed from the lower opening end.

Next, 200 g of Chinese soup was packed as contents from the lower opening end of the packaging bag, and heat fusing was carried out at the side seal part 5 to prepare a packaged body according to the present invention (longitudinal width: 150 mm, lateral width: 60 mm, height: 140 mm) as shown in FIG. 2B.

The food packaged body thus obtained was heated in a self-supported state in a 500-W microwave oven. As a result, the food packaged body was stably and satisfactorily cooked on a tray being rotated within the microwave oven without overturning. About 1.5 min after the initiation of cooking, steam was quickly vented through the cut 20, there was no boiling-over of the Chinese soup, and the Chinese soup could safely be taken out of the opening of the Chinese soup-packaged bag.

### Comparative Example 2-1

In the same manner as in Example 2-1, a packaging bag of Comparative Example 2-1 was prepared using the same laminated film as in Example 2-1, except that no point seal part was used.

200 g of Chinese soup was packed as contents into the packaging bag thus obtained, and the top seal part 6 was sealed for hermetical sealing of the bag. Thereafter, the bag was heated in a self-supported state within a 500-W microwave oven.

As a result, upon heating in the microwave oven, the packaged body was inflated, and, about 1 min 50 sec after the initiation of heating, vapor was vented through the side seal part with big sound, resulting in breaking of the bag from the side seal part which caused the contents to be scattered within the microwave oven.

### Comparative Example 2-2

In the same manner as in Example 2-1, a packaging bag of Comparative Example 2-2 was prepared using the same laminated film as in Example 2-1, except that the dimension of the bag was changed.

200 g of Chinese soup was packed as contents into the packaging bag thus obtained. The top seal part was sealed, followed by hermetical sealing of the bag to prepare a packaged body of Comparative Example 2-2 (longitudinal width: 140 mm, lateral width: 60 mm, height: 150 mm).

The point seal part 9 was provided at such a position that the radius r3 of the circle in contact with the lowermost end of the point seal part 9 from the center of the packaging bag was 70 mm, the radius r1 of the circle in contact with the inner edge of the side seal part 5 was 60 mm, and the radius r1 was larger than the radius r3. Next, in the same manner as in Example 2-1, the packaged body of Comparative Example 2-2 was heated in a self-supported state within a 500-W microwave oven. As a result, upon heating within the microwave oven, the packaged body was inflated. About 2 min after the initiation of heating, steam was vented through a vapor opening. However, considerable outward peeling of the side seal part was observed. Further, the packaged body 300 was considerably inflated before the vapor was vented, and, thus, there was a fear of breaking of the bag.

### Example 3-1

A 12 μm-thick alumina-deposited polyethylene terephthalate film, a 15 μm-thick stretched nylon film, and a 60 μm-thick unstretched polypropylene film were dry laminated on top of one another with the aid of a urethane adhesive to prepare a packaging material. This packaging material was used to prepare a packaging bag, for a microwave oven, having a horseshoe-shaped seal part 9 and a holding means 21 according to the present invention (outer dimension: height 140 mm, width 150 mm) as shown in FIG. 7A (c: 25 mm, d: 15 mm, e: 10 mm, f: 5 mm, diameter of notch: 8 mm).

210 g of curry was packed as contents into the packaging bag thus obtained. The top seal part 7 was sealed, and the bag was hermetically sealed. The bag was then subjected to retorting at 120° C. for 30 min. The bag was heated in a self-supported state in a 500-W microwave oven. As a result, the food packaged body was stably and satisfactorily cooked on a tray being rotated within the microwave oven without overturning. About 1 min 20 sec after the initiation of cooking, steam was quickly vented through the notch, and there was no boiling-over of the contents. The large-width seal part was grasped to take the bag out of the microwave oven. As a result, the bag could be safely taken out of the microwave oven without causing burning, and the curry could easily be taken out of the bag.

1. A food packaging bag formed of a laminated film comprising at least a base layer and a sealant layer, said sealant layer being located on the interior side of said packaging bag, said packaging bag having therewithin a point seal part connected to or independently of its edge part, said point seal part having in its area an easy-vapor-passing part.

2. The food packaging bag according to claim 1, wherein said easy-vapor-passing part is provided at such a position that, when circles are drawn about the center part of said packaging bag, the radius of the circle in contact with the inner edge of the lowermost end in said easy-vapor-passing part from the center of said packaging bag is smaller than the radius of the circle in contact with the inner edge of the edge part in said packaging bag.

3. The food packaging bag according to claim 1, wherein said point seal part has in its area an unbonded part, a weakly bonded part, or a patterned seal part.

4. The food packaging bag according to claim 1, wherein said easy-vapor-passing part is at least one notch or cut provided in the area of said point seal part.

5. The food packaging bag according to claim 4, wherein the distance between the lowermost end of said at least one notch or cut provided in said point seal part and the lower end of said point seal part is 2 to 10 mm.

6. The food packaging bag according to claim 1, wherein said point seal part has a seal strength of not less than 23 N/15 mm and not more than 100 N/15 mm in a 23° C. temperature region and not less than 5 N/15 mm and not more than 25 N/15 mm in a 90° C. temperature region.

7. The food packaging bag according to claim 1, wherein at least one wide seal part is provided in the peripheral part in said packaging bag.

8. The food packaging bag according to claim 1, which comprises at least a front laminated film, a rear laminated film, and a bottom laminated film and is a self-supporting packaging bag.

9. The food packaging bag according to claim 8, wherein a print is provided on said front laminated film and said rear laminated film and said bottom laminated film is transparent and can see the contents of said bag therethrough.

10. The food packaging bag according to claim 1, which further comprises a fastener or a zipper that can reclose said packaging bag.

11. A food-packaged body consisting essentially of the packaging bag according to claim 1 and a food which has been packed and hermetically sealed in said packaging bag.

12. A method for manufacturing a food-packaged body, comprising the steps of:
(a) providing a laminated film comprising at least a base layer and a sealant layer and folding back or superimposing said laminated film in such a manner that said sealant layer faces inward;
(b) bonding the edge while leaving a food packing opening to form a packaging bag;
(c) forming a point seal part within said packaging bag, connected to or independently of said edge;
(d) forming an easy-vapor-passing part in the area of said point seal part;
(e) packing a food into said packaging bag; and
(f) after said step (e), hermetically sealing said packaging bag,
said steps (b) to (d) being carried out in any desired order after said step (a) and being followed by said step (e) and said step (f).

13. The method according to claim 12, wherein said food is cooked rice prepared by washing rice, immersing the washed rice in water, draining the rice, and cooking and steaming the rice, or cooked rice prepared by washing rice and either cooking and steaming the rice or immersing the rice in hot water, then immersing the rice in cold water, and either blowing air against the rice or allowing the rice to cool at room temperature.

14. The method according to claim 12, which further comprises (g) the step of packing said food into said packaging bag, hermetically sealing the packaging bag, and then subjecting the bag to retort sterilization.

15. The method according to claim 12, wherein at least one of water, ingredients, flavoring materials, and fats and oils is added to said food.
